(19) United States
(12) Patent Application Publication
(10) Pub. No.: US 2007/0294190 A1
(43) Pub. Date: Dec. 20, 2007

(54) Real estate market strength indicator

(76) Inventor: Nate Sumner, Mill Valley, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/450,506

(22) Filed: Jun. 9, 2006

(51) Int. Cl. G06Q 40/00

(52) U.S. Cl. 705/36 R

(57) ABSTRACT

A method and apparatus for evaluating the strength of a specified real estate market. The market is first identified, and then relevant information is gathered, including total number of sales S_{C} closed within a period of time, total number of sales S_{P} currently pending, and total number of active sales listings L currently pending. An index I is then calculated, wherein I=(S_{C}+S_{P})/L. The index I is then used to evaluate the strength of the specified real estate market.

### TECHNICAL FIELD

This disclosure relates generally to analysis of real estate markets, and more particularly, to a method and apparatus for evaluating the strength of a specified real estate market.

### BACKGROUND

The market for real estate in the United States is a dynamic and potentially volatile field subject to fluctuation and affected by many external factors. For example, on a most basic level, the number of buyers and sellers in a specified marketplace, such as the market for single-family residential homes in Marin County, Calif., establishes the local demand for such homes, and therefore has a direct bearing on reasonable sales prices. Additional factors, such as interest rates, rate of inflation, cost of living, strength of local economy, new home construction, etc., also impact the market demand. Different markets, such as commercial real estate, have other relevant factors, such as vacancy rates, leasing rates, etc., that affect market demand.

Real estate professionals have long sought tools to help them evaluate real estate markets in order to advise clients in every conceivable type of real estate market, whether broadly defined as residential or commercial markets, or more narrowly defined, for example, single-family homes, condominiums, or apartments. There are many publications and subscription services devoted to discussions of real estate data and trends. For example, The National Real Estate Index (http://www.graglobal.com) publishes quarterly reports that provide comprehensive analyses of real estate data for 60 major U.S. markets. Another organization, Hanley Wood Market Intelligence (web site: http://www.meyersgroup.com/homebuilding/homebuilding.asp) provides data and consulting services to residential real estate developers in 75 of the top U.S. markets, including data on housing supply and demand, economic indicators, and other relevant factors. The National Review of Real Estate Markets is a subscription newsletter that provides a wealth of real estate data, such as home sales by price range, vacancy rate, new housing permits, job growth and related jobs data, for 100 of the top U.S. markets. These type of resources provide so much data that it is often difficult to know which data is important for a particular client's interests, and more critically, what conclusion is to be drawn from the data. Therefore, it would be desirable to have a tool that could focus on the really important data and provide a consistent methodology for utilizing the data to evaluate the strength of the real estate market being considered.

One such methodology is disclosed in U.S. Pat. No. 6,058,369, which teaches a method whereby several indices are mathematically derived from specific data, including the total number of real estate sales which have closed in the period of interest, the total number of sales pending at the end of the period, the total number of listings which expired or were otherwise removed during the period, and the total number of active listings at the time of inquiry. The indices are manipulated to provide indications of demand and risk, and then used, for example, by lenders to determine whether or not to extend credit, or by title companies to determine whether or not to extend insurance coverage.

From the foregoing, it remains desirable to have an indicator of market strength that is easy to use and consistent in its application.

### SUMMARY

The present disclosure describes a method and an apparatus for evaluating the strength of a specified real estate market. The market is first identified. Then, relevant information is gathered from a database, like the Multiple Listing Service database, including total number of sales S_{C} closed within a period of time, total number of sales S_{P} currently pending, and total number of active sales listings L currently pending. An index I is calculated, wherein I=(S_{C}+S_{P})/L. The index I is then used to evaluate the strength of the specified real estate market. For example, an index near 1.0 indicates a balanced market, whereas an index above 1.25 indicates a seller's market and an index below 0.80 indicates a buyer's market. Preferably, the time period of interest is 30 days.

In a particularly preferred implementation, the asking price for each home is obtained from the database, and the specified market is then divided into segments corresponding to asking price. Alternatively, the specified market may be divided into segments corresponding to individual cities.

A further understanding of the nature and advantages of the present invention may be realized by reference to the remaining portions of the specification and the drawings.

### BRIEF DESCRIPTION OF THE DRAWINGS

FIG. 1 is a flow chart illustrating a preferred method for calculating an index I.

FIG. 2 is a bar chart showing an index I for different price segments.

FIG. 3 is a graph showing historical values for one price segment from FIG. 2.

FIG. 4 is a bar chart showing an index for different cities.

FIG. 5 is a graph showing historical values for one city from FIG. 4.

### DETAILED DESCRIPTION OF SPECIFIC EMBODIMENTS

The present disclosure provides a method and apparatus for determining the relative strength of a real estate market. We describe a preferred application of the method to a market for residential properties, but the teachings herein have equal applicability to any type of real estate market, and are not intended to be limited by the description of a preferred embodiment.

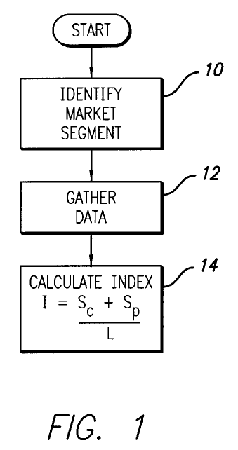

Referring now to FIG. 1, a simple flow chart illustrates a method for calculating an index that is useful as an indicator of the intensity of buyer competition for listed properties in a specified real estate market. At step 10, the relevant market segment to be evaluated is identified. For example, the residential market may be identified as Marin County, Calif. It should be recognized that the market of interest could be identified in a wide variety of ways, i.e., by county, by city, by price range, etc.

At step 12, relevant data is gathered. Preferably, raw data is obtained from the Multiple Listing Service® (“MLS”), which is available by subscription to licensed real estate brokers, simply by connecting to the Internet via a personal computer, or from other sources. MLS tracks and compiles information regarding local real estate markets and is available for most geographical areas in the United States. Further, relevant MLS information can be readily obtained through use of a personal computer and an appropriate search strategy. It may be necessary to forge an agreement with one or more sources of raw data such as a particular MLS provider.

In this embodiment, the specific information required includes (1) the total number of closed residential sales within the last 30 days, S_{C}; (2) the total number of current pending residential sales (including all sales “in contract” status), S_{P}; and (3) the total number of currently active (available) residential listings, L. An indicator I of market strength is then calculated in step 14 by the equation: I=(S_{C}+S_{P})/L. Advantageously, the value for indicator I is close to 1 when there is a relatively balanced market, i.e., equal numbers of buyers and sellers. With higher numbers, there is more buyer competition for each listed home on the market. Lower numbers indicate less intense, lower levels of buyer competition for each listed home. For example, when the indicator I has a value of approximately 1.25 or higher, the market is clearly a “seller's market.” For sellers, this means they should expect a positive reaction when listing the home, with possible multiple offers and busy bidding. Correspondingly, buyers should expect to compete with other buyers in multiple offer situations on attractive homes that are reasonable priced.

When the indicator I has a value of approximately 0.80 or lower, the market is clearly a “buyer's market.” For buyers, this means they should bargain with seller on price or other terms. Sellers should expect their home to be on the market for a while before receiving an offer, and know that when it comes, the offer will likely be for less than the asking price. The seller should be prepared for the buyer to bargain about price or other terms.

The indicator I may be used in a variety of ways to provide a snapshot of market conditions and trends. For example, in Table I below, data is summarized for sales and listings of single family dwellings (“SFD's”) and condominiums in Marin County by price range, with a county total at the bottom. In this example, the price range for SFD's is divided into segments like a modified bell curve. Advantageously, the seven price segments are derived by applying a percentage to the total listings of single-family dwellings (condos excluded). Thus, the first tier, or top of the market, is defined by the prices in the top 6% of active SFD listings. The second tier is defined by prices in the next 17% of active SFD listings. The third tier is defined by prices in the next 13% of active SFD listings. The fourth tier is defined by prices in the next 22% of active SFD listings. The fifth tier is defined by prices in the next 22% of active SFD listings. The sixth tier is defined by prices in the next 18% of active SFD listings. The seventh or last tier is defined by prices in the last 2% of active SFD listings. Condominium sales are also listed, but are lumped into a single category.

TABLE I

| | | | | Pending | | | |
|---|---|---|---|---|---|---|---|
| | | | | Sales plus | | | |
| | | | Ratio: | closed in | Active | Closed in | |
| Price | Listed | Pending | Pending:Listed | last 30 days | Listings | last 30 days | Index I |
| >$4 mil | 52 | 5 | 10.00 | 9 | 47 | 4 | 0.19 |
| $2–4 mil | 156 | 36 | 23.00 | 57 | 120 | 21 | 0.48 |
| $1.5–2 mil | 120 | 29 | 24.00 | 45 | 91 | 16 | 0.49 |
| $1–1.5 mil | 184 | 57 | 31.00 | 112 | 127 | 55 | 0.88 |
| $800K–$1 mil | 196 | 90 | 46.00 | 149 | 106 | 59 | 1.41 |
| $600K–800K | 161 | 57 | 35.00 | 100 | 104 | 43 | 0.96 |
| <$600K | 15 | 5 | 33.00 | 8 | 10 | 3 | 0.80 |
| condos | 246 | 70 | 28.00 | 131 | 176 | 61 | 0.74 |
| TOTAL | 1132 | 350 | 31.00 | 610 | 782 | 260 | 0.78 |
| Marin | | | | | | | |
| County | | | | | | | |

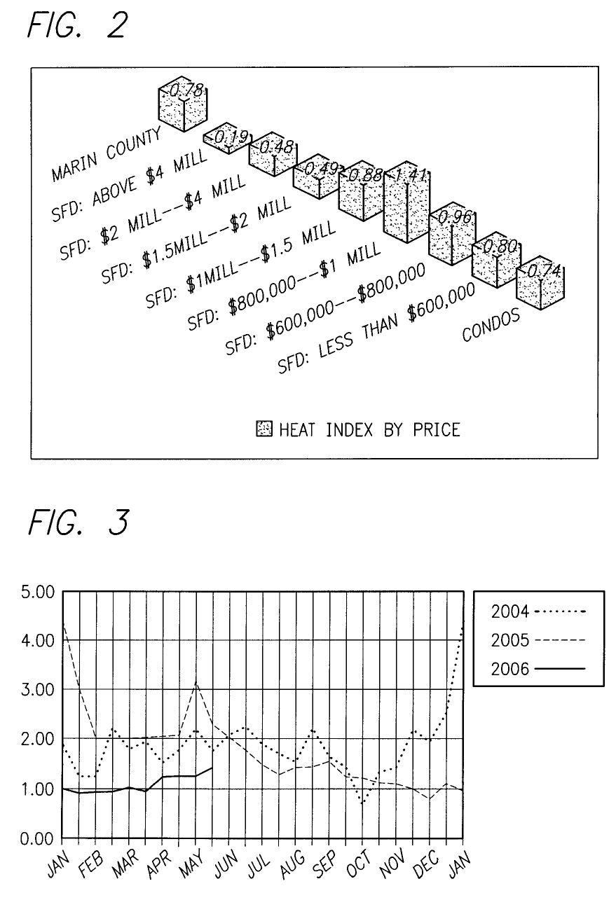

The indicator I can thus provide a more detailed snapshot of particular price segments in the market. For example, although the data for Marin County as a whole appears to indicate a buyer's market, it is clear that for individuals looking at homes in the $800,000 to $1,000,000 price range, it is a seller's market. The segments on either side of that price range are closer to a neutral or balanced market. As the price range exceeds $1,500,000, or drops below $600,000, the data indicates a buyer's market exists for those segments. Advantageously, these relationships can be graphed as shown in FIG. 2. Further, each of these segments may be evaluated historically. For example, historical data for the $800,000 to $1,000,000 price range is graphed in FIG. 3. It can be seen from the graph that this segment has been primarily a seller's market for the last several years.

In Table II below, data is summarized for sales and listings in Marin County by city.

TABLE II

| | | | | Pending | | | |
|---|---|---|---|---|---|---|---|
| | | | | Sales plus | | | |
| | | | Ratio: | closed in | Active | Closed in | |
| City | Listed | Pending | Pending:Listed | last 30 days | Listings | last 30 days | Index I |
| MARIN CO. | 1132 | 350 | 31.00 | 610 | 782 | 260 | 0.78 |
| Belvedere | 28 | 8 | 29.00 | 12 | 20 | 4 | 0.60 |
| Corte Madera | 19 | 12 | 63.00 | 22 | 7 | 10 | 3.14 |
| Fairfax | 29 | 11 | 38.00 | 22 | 18 | 11 | 1.22 |
| Greenbrae | 21 | 10 | 48.00 | 17 | 11 | 7 | 1.55 |
| Kentfield | 33 | 7 | 21.00 | 14 | 26 | 7 | 0.54 |
| Larkspur | 30 | 11 | 37.00 | 18 | 19 | 7 | 0.95 |
| Mill Valley | 119 | 34 | 29.00 | 80 | 85 | 46 | 0.94 |
| Novato | 295 | 56 | 19.00 | 124 | 239 | 68 | 0.52 |
| Ross | 23 | 4 | 17.00 | 7 | 19 | 3 | 0.37 |
| San Anselmo | 56 | 21 | 38.00 | 36 | 35 | 15 | 1.03 |
| San Rafael | 178 | 70 | 39.00 | 177 | 108 | 107 | 1.64 |
| Sausalito | 66 | 16 | 24.00 | 29 | 50 | 13 | 0.58 |
| Tiburon | 89 | 19 | 21.00 | 27 | 70 | 8 | 0.39 |
| Other Marin | 94 | 20 | 21.00 | 25 | 74 | 5 | 0.34 |

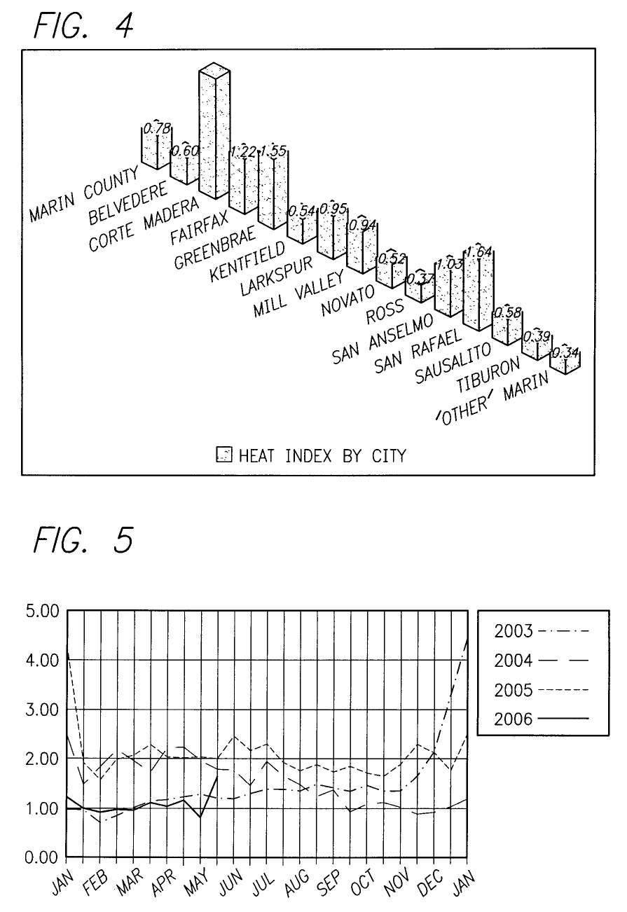

Again, although the data for Marin County as a whole appears to indicate a buyer's market, it is clear that for individuals looking at homes in particular markets, such as Corte Madera, Greenbrae, and San Rafael, that it is a seller's market. Larkspur, Mill Valley, San Anselmo, and maybe Fairfax, are closer to a neutral or balanced market. A buyer's market exists for the remaining cities. Advantageously, these relationships can be graphed as shown in FIG. 4. Further, each of these segments may be evaluated historically. For example, historical data for the San Rafael market segment is graphed in FIG. 5. It can be seen from the graph that this segment has been primarily a seller's market for the last several years.

In general, those skilled in the art to which this invention pertains will recognize that many variations and differing embodiments will suggest themselves without departing from the spirit and essential characteristics of the invention. Accordingly, the disclosures and descriptions herein are intended to be illustrative only, and not limiting. The scope of the invention is set forth in the claims.

I claim:

1. A method for evaluating the strength of a specified teal estate market, comprising:
gathering relevant information regarding the specified real estate market, including total number of sales S_{C} closed within a period of time, total number of sales S_{P} currently pending, and total number of active sales listings L currently pending;
calculating an index I, wherein I=(S_{C}+S_{P})/L; and
using the index I to evaluate the specified teal estate market.

2. A method as in claim 1, wherein an index I above approximately 1.25 indicates a sellers' market.

3. A method as in claim 1, wherein an index I below approximately 0.80 indicates a buyers' market, and

4. A method as in claim 1, wherein an index I close to approximately 1.00 indicates a balanced market.

5. A method as in claim 1, wherein the period of time is 30 days.

6. A method as in claim 1, wherein the gathering step includes obtaining asking price for each listing, and further comprising dividing the specified real estate market into a plurality of price segments, and calculating an index I for each price segment.

7. A method as in claim 6, wherein the price segments ate arranged like a modified bell curve about a median asking price.

8. A method as in claim 6, wherein the price segments are set in accord with preset conditions.

9. A method as in claim 8, wherein the price segments are set as a percentage of the active listings L.

10. A method as in claim 9, wherein the price segments include a first tier, which includes the top 6% of the active listings L, a second tier, which includes the next 17% of the active listings L, a third tier, which includes the next 13% of the active listings L, a fourth tier, which includes the next 22% of the active listings L, a fifth tier, which includes the next 22% of the active listings L, a sixth tier, which includes the next 18% of the active listings L, and a seventh tier, which includes the last 2% of the active listings L.

11. A method as in claim 1, wherein the index I is calculated to provide historical data.

12. An apparatus for evaluating the strength of a specified real estate market, comprising:
a computer;
a database of real estate information accessible by the computer, including total number of sales S_{C} closed within a period of time, total number of sales S_{P} currently pending, and total number of active sales listings L currently pending; and
a program running on the computer that calculates an index I, wherein I=(S_{C}+S_{P})/L, wherein the index I is used to evaluate the specified real estate market.

13. An apparatus as in claim 12, wherein an index I above approximately 1.25 indicates a sellers' market.

14. An apparatus as in claim 12, wherein an index I below approximately 0.80 indicates a buyers' market, and

15. An apparatus as in claim 12, wherein an index I close to approximately 1.00 indicates a balanced market.

16. An apparatus as in claim 12, wherein the period of time is 30 days.

17. An apparatus as in claim 12, wherein the database includes an asking price for each listing, and wherein the specified real estate market is divided into a plurality of price segments, and an index I is calculated for each price segment.

18. An apparatus as in claim 17, wherein the price segments are arranged like a bell curve about a median asking price.

19. An apparatus as in claim 17, wherein the price segments are set in accord with preset conditions.

20. An apparatus as in claim 17, wherein the price segments are set as a percentage of the active listings L.

21. An apparatus as in claim 20, wherein the price segments include a first tier, which includes the top 6% of the active listings L, a second tier, which includes the next 17% of the active listings L, a third tier, which includes the next 13% of the active listings L, a fourth tier, which includes the next 22% of the active listings L, a fifth tier, which includes the next 22% of the active listings L, a sixth tier, which includes the next 18% of the active listings L and a seventh tier, which includes the last 2% of the active listings L.

22. An apparatus as in claim 12, wherein the index I is calculated to provide historical data.
